(19) United States
(12) Patent Application Publication
(10) Pub. No.: US 2015/0371330 A1
(43) Pub. Date: Dec. 24, 2015

(54) METHODS SYSTEMS AND DEVICES FOR MITIGATING RISK IN DISTRIBUTED ENERGY ASSETS

(71) Applicants: Nalin Kulatilaka, Brookline, MA (US); David Arfin, Palo Alto, CA (US)

(72) Inventors: Nalin Kulatilaka, Brookline, MA (US); David Arfin, Palo Alto, CA (US)

(21) Appl. No.: 14/743,705

(22) Filed: Jun. 18, 2015

Related U.S. Application Data
(60) Provisional application No. 62/014,339, filed on Jun. 19, 2014.

(51) Int. Cl. G06Q 40/04

(52) U.S. Cl. CPC G06Q 40/04

(57) ABSTRACT

Devices, systems, and methods for mitigating risk in distributed energy assets are disclosed. In one aspect a computerized method comprises purchasing a bundle of distributed energy assets comprising agreements by end-users of distributed energy resources to purchase energy at variable rates which are tied to future utility rates or an index and swapping with one or more off-takers a variable stream of cash flows based on a variable future utility rate for a fixed stream of cash flows based on a fixed rate.

### CROSS-REFERENCES TO RELATED APPLICATIONS

This application claims the benefit and priority of U.S. Provisional Application No. 62/014,339, entitled “METHODS SYSTEMS AND DEVICES FOR MITIGATING RISK IN DISTRIBUTED ENERGY ASSETS”, filed on Jun. 19, 2014, the full disclosure of the above referenced application is incorporated herein by reference.

### FIELD OF THE INVENTION

This invention relates generally to methods, systems, and devices for mitigating risk in distributed energy assets.

### DESCRIPTION OF THE RELATED ART

Energy generating or energy efficiency equipment can provide substantial utility savings as well as environmental benefits. Often though, purchasing this equipment may be prohibitively expensive and it might take a long time to recoup the initial investment through savings derived from the system. Assets such as equipment loans, equipment leases, power purchase agreements, shared savings agreements, and energy service agreements have been created in order to reduce or remove upfront cost allowing a much larger user base.

In order for investors, developers, lenders, or installers to gauge the risk involved in these assets, factors such as credit rating of the user, utility rates, expected production, projected energy and economic savings, etc. are often examined before creating the asset or installing equipment. Assets such as these may have long economic lives and thus risk factors could change significantly during the life of the asset. These static determinations of risk therefore poorly represent risk after creation of the asset and adoption of equipment. Also, users of electricity may have different preferences with regard to fixed vs. variable payments for future usage.

A key risk in distributed energy assets is tariff risk. Adopters of equipment under fixed-rate leases or PPAs bare all the risk that the tariffs will rise at a lower rate than projected. This may be neither trivial nor a risk many prospective adopters would prefer to take on if they had an option. Moreover, some potential adopters will forego the investment in this system because of their unwillingness take on this economic risk.

It would be desirable to provide alternative and improved methods, systems, and devices for mitigating risk in distributed energy assets. At least some of these objectives will be met by the invention described herein below.

### SUMMARY OF THE INVENTION

In one aspect, the present application discloses methods, systems, and devices for mitigating risk in distributed energy assets. In one embodiment a computerized method for mitigating risk in distributed energy assets is disclosed, comprising purchasing, using a processor, a bundle of distributed energy assets, wherein the distributed energy assets comprise agreements by end-users of distributed energy resources to purchase energy at variable rates which are tied to future utility rates or an index; and swapping with one or more off-takers, using the processor, a variable stream of cash flows based on a variable future utility rate and energy quantity for the off-taker for a fixed stream of cash flows based on a fixed rate and the energy quantity for the off-taker. Variable rates of the distributed energy assets may be discounted by a percentage or a fixed value from the future utility rates for the end-users. The variable rates of the distributed energy assets may also be tied to average national utility rates, average regional utility rates, commodity prices, home prices, or inflation.

In another embodiment a computerized method for mitigating risk in distributed energy assets is disclosed, comprising purchasing, using a processor, a bundle of distributed energy assets comprising agreements by end-users of distributed energy resources to purchase energy at fixed rates; and swapping with one or more off-takers, using the processor, a variable stream of cash flows based on a variable future utility rate and energy quantity for the off-taker for a fixed stream of cash flows based on a fixed rate and the energy quantity for the off-taker.

In various embodiments, the distributed energy resources comprises photovoltaic, solar thermal, wind energy, heating, cooling, HVAC, insulation, water processing, or water purifying equipment.

In another aspect, the methods further comprise identifying the bundle of distributed energy assets, receiving energy-related data associated with the bundle of distributed energy assets, calculating future payments from the bundle of distributed energy assets based on the energy-related data associated with the bundle of distributed energy assets, identifying the off-taker, receiving energy-related data associated with the off-taker, calculating future cash flows to the off-taker based on the energy-related data associated with the bundle of distributed energy assets, and matching the bundle of distributed energy assets with the off-taker based on the calculated future payments from the bundle of distributed energy assets and the calculated future cash flows to the off-taker. Received energy-related data associated with the bundle of distributed energy assets or received energy-related data associated with the off-taker may comprise data relating to changes to regulations, taxes, government incentives, utility incentives, usage data, equipment performance data, utility pricing, macroeconomic data, weather, or technology data. Calculating future payments from the bundle of distributed energy assets may comprise calculating estimated future utility rates or energy quantities for the bundle of distributed energy assets. Calculating future cash flows to the off-taker may comprise calculating estimated future utility rates or energy quantities for the off-taker.

This, and further aspects of the present embodiments are set forth herein.

### BRIEF DESCRIPTION OF THE DRAWINGS

Present embodiments have other advantages and features which will be more readily apparent from the following detailed description and the appended claims, when taken in conjunction with the accompanying drawings, in which:

FIG. 1 shows exemplary distributed energy assets.

FIGS. 2-5 show systems for mitigating risk in distributed energy assets.

FIGS. 6 and 7 shows methods of matching distributed energy assets with an off-taker.

FIG. 8 shows an exemplary method of calculating estimated future retail utility rates for a utility customer.

FIG. 9 illustrates an exemplary system architecture according to one embodiment.

FIG. 10 illustrates an exemplary system architecture with various end-user and off-taker data sources.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

The present disclosure describes methods, systems, and devices for mitigating risk in distributed energy assets comprising agreements by end-users of distributed energy resources to purchase energy. The term “energy” as referred to herein is defined to include electricity, natural gas, water, heating oil, and the like. The term “distributed energy resources” as referred to herein is defined to include energy or water related equipment such as energy generating systems (photovoltaic, solar hot water, solar thermal, wind energy, geothermal energy, hydroelectric, combined heat and power), distributed energy equipment, energy or water efficient equipment (appliances, lighting, HVAC, insulation, smart devices, sensors), heating/cooling systems (heating oil, gas, geothermal heat pumps), energy storage systems (battery storage, fuel cell systems, thermal storage, fly wheels, electric vehicles), systems for cleaning, processing, storing, or purifying water, energy efficient vehicles (electric, hybrid, fuel cell, etc.), and/or software that allocates/optimizes generation or usage of the above systems. In an embodiment, distributed energy resources may comprise demand-side management programs such as demand response and continuous commissioning.

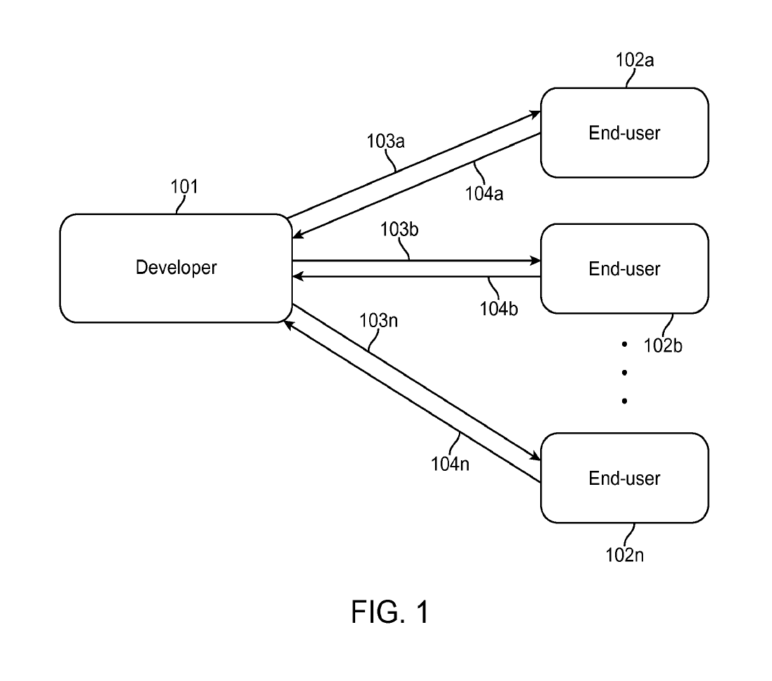

Distributed energy resources may provide substantial energy or utility savings to residential, commercial, industrial, agricultural, governmental, educational, nonprofit, or any other user of energy or water. Often though, the initial investment to adopt such equipment can be quite large. Distributed energy assets such as equipment leases, equipment loans, power purchase agreements, shared savings agreements, energy service agreements, or the like, allow adoption of such equipment with reduced upfront cost to end-users of the distributed energy resources. FIG. 1 depicts exemplary distributed energy assets. Developer 101 enters into agreements with end-users 102a-n of distributed energy resources wherein developer 101 finances, installs, and/or leases distributed energy resources at a cost 103a-n in exchange for cash flows 104a-n from the end-users 102a-n. In an embodiment, end-users 102a-n agree to purchase energy produced by adopted energy generating equipment such as a photovoltaic system. End-users may sign up for long term contracts at set prices, often with time-based escalators embedded in the leasing or power purchase agreement. Distributed energy assets may have cash flows 104a-n of various durations that are borrowed against and/or sold into securitization markets. Distributed energy assets may comprise contracts to purchase all electricity produced from an energy-generating system over a given period. Alternatively, distributed energy assets may comprise contracts to purchase all consumed energy during a given period. Assets may be packaged or bundled with similar assets. They may, in turn, be repackaged, re-priced and resold.

In an embodiment, distributed energy assets may comprise agreements by end-users 102a-n to purchase energy at fixed rates projected to be less than estimated future utility rates for the end-users 102a-n. Data from various sources such as data relating to regulations, taxes, government incentives, utility incentives, usage data, equipment performance data, utility pricing, macroeconomic data, weather, or technology data may be used to calculate estimated future utility rates.

As future changes in energy rates may be derived from tariff and pricing decisions of public utility commissions and utilities, technological developments, macroeconomic forces such as recession, events such as closing of power plants, developments of energy sources/distribution, or commodity prices, it is possible that actual future electricity rates/tariffs differ from the projections. Some potential end-users 102a-n may forego the investment in this system because of the uncertainty resulting from the economic risk they are taking on. In an alternative embodiment, developer 101 provides end-users 102a-n with a savings guarantee wherein end-users 102a-n agree to purchase energy at variable rates which are tied to future utility rates or an index. In an embodiment, the variable rates of the distributed energy assets are discounted by a percentage from the future utility rates for the end-users. For example, the end-user 102a-n may agree to purchase energy at a five percent discount from future utility rates. Alternatively, variable rates of the distributed energy assets may discounted by a percentage from the total utility bill. Variable discounts from total bills may consider changes to net metering, energy demand or capacity charges, and/or surcharges/penalties/fees or discounts for customers who deploy distributed resources. In another embodiment, the variable rates of the distributed energy assets are discounted by a fixed value from the future utility rates for the end-users 102a-n. For example, end-users may agree to purchase energy at a reduced rate. Assets may guarantee a fixed discount per month from the total end-user utility bill. Fixed discounts from total bills may consider changes to net metering, energy demand or capacity charges, or surcharges/penalties/fees or discounts for customers who deploy distributed resources. For example, the energy-related asset may guarantee a saving of $10 month. Additionally or alternatively, variable rates may be tied to average national utility rates, average regional utility rates, commodity prices, home prices, or inflation. While the term “discount” is used, it is also contemplated that the variable rates may be equal to or greater than future utility rates or indices. The variable rates will thus increase the number of potential end-users 102a-n as well as reduce the risk of default since the distributed energy assets will always be beneficial to the end-users 102a-n.

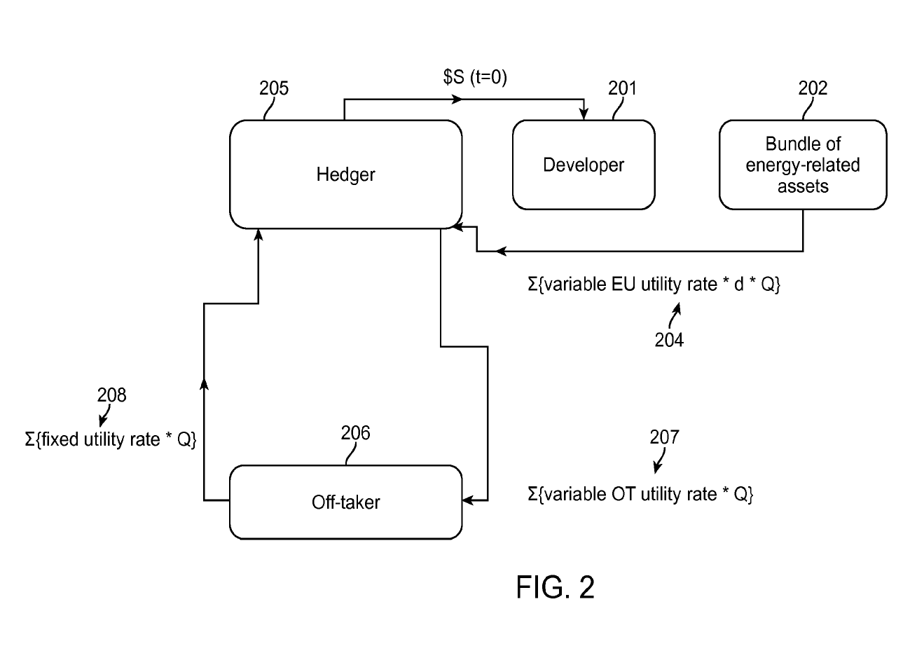

FIG. 2 shows a system for mitigating risk in distributed energy assets. This exemplary system comprises a developer 201, a bundle of energy related assets 202, a hedger 205, an off-taker 206, and an investor 209. Hedger 205 purchases a bundle of distributed energy assets 202 from developer 201 for price $S. While a bundle of energy assets 202 is depicted, alternatively hedger 205 may purchase a single energy related asset.

Hedger 205 receives a variable stream of cash flows 204 from the bundle of distributed energy assets 202 tied to variable future end-user utility rates or an index. As described above, the variable payments 204 from the bundle of distributed energy assets 202 may be based on a variable future utility rate, a discount, and an energy quantity for the end-users.

Hedger 205 swaps with one or more off-takers 206 a variable stream of cash flows 207 based on a variable future utility rate and energy quantity for the off-taker 206 for a fixed stream of cash flows 208 based on a fixed rate and the energy quantity for the off-taker 206. Off-taker 206 could be anyone seeking long-term rate stability such as a commercial or industrial entity or a speculator betting on future electricity rates. Payments 204 are used to service forward contracts hedger 205 writes with the off-taker 206 thus effectively swapping the variable stream cash flows 204 from the bundle of distributed energy assets with the variable stream of cash flows 207 to the off-taker 206.

End-users and off-taker 206 may be in different geographic regions having different utility rates. Additionally, end-users and off-taker 206 may be in different sectors such as residential, commercial, industrial, or agricultural with differing tariffs. Therefore the variable stream of cash flows 204 from the bundle of distributed energy assets 202 may differ from the variable stream of cash flows 207 to the off-taker 206 and thus hedger 205 bares the basis risk. In an embodiment, the hedger 205 matches the bundle of distributed energy assets 202 with potential off-takers 206 based on predicted cash flows in order to minimize the basis risk. The variable stream of cash flows 204 from the bundle of distributed energy assets 202 may also be tied to the variable stream of cash flows 207 to the off-taker 206.

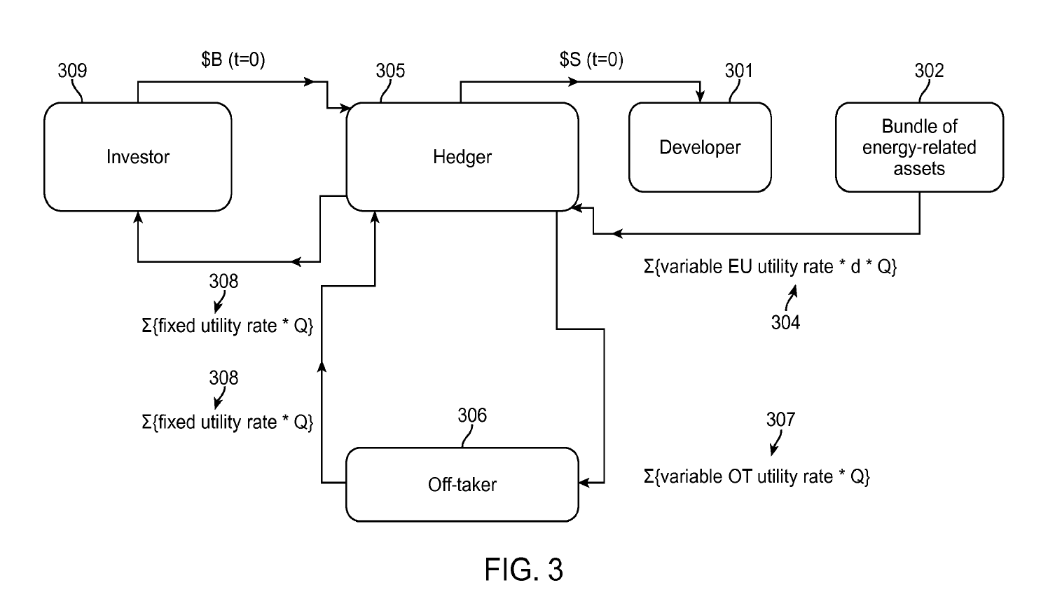

FIG. 3 depicts a similar system for mitigating risk in distributed energy assets further comprising an investor 209. Hedger 306 may sell to an investor 309 the fixed stream of cash flows 308 from the off-taker 306 for a price $B which may be used to purchase the bundle of distributed energy assets 302. In an embodiment, sale price $B is greater than or equal to the purchase price $S of the bundle of distributed energy assets 302.

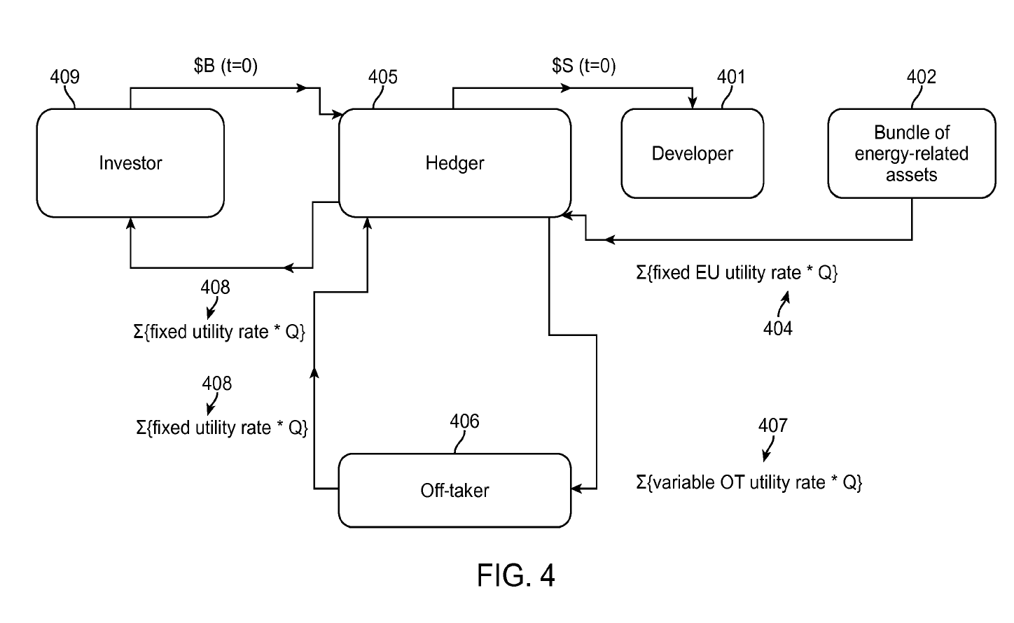

FIG. 4 is an alternative system for mitigating risk in distributed energy assets wherein the bundle of distributed energy assets 402 comprise agreements by end-users of distributed energy resources to purchase energy at fixed rates projected to be less than estimated future utility rates for the end-users. Hedger 405 receives a fixed stream of cash flows 404 from the bundle of distributed energy assets 402 based on a fixed rate and an energy quantity for the end-users. Various data sources such as data relating to regulations, taxes, government incentives, utility incentives, usage data, equipment performance data, utility pricing, macroeconomic data, weather, or technology data may be used to calculate estimated future utility rates for the end-users.

Hedger 405 swaps with one or more off-takers 406 a variable stream of cash flows 407 based on a variable future utility rate and energy quantity for the off-taker 406 for a fixed stream of cash flows 408 based on a fixed rate, and the energy quantity for the off-taker 406. Payments 404 are used to service forward contracts hedger 405 writes with the off-taker 406 thus effectively swapping the fixed stream cash flows 404 from the bundle of distributed energy assets with the variable stream of cash flows 407 to the off-taker 406. Hedger 405 may match the bundle of distributed energy assets 402 with potential off-takers 406 based on predicted cash flows in order to minimize the basis risk.

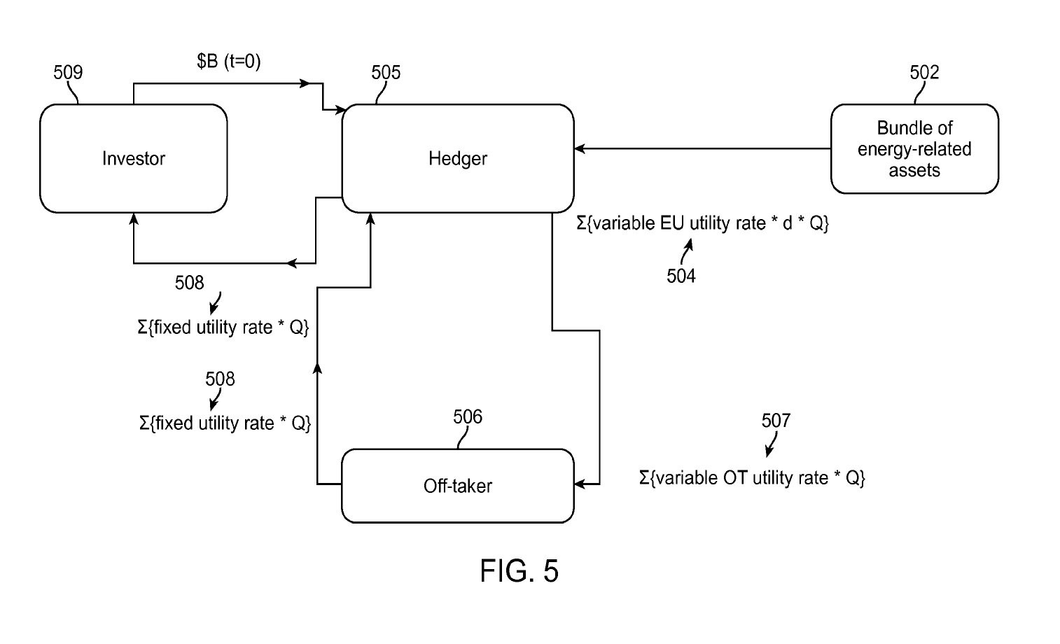

FIG. 5 shows an alternative system for mitigating risk in distributed energy assets without a separate developer. Hedger 505 enters into agreements with end-users of distributed energy resources wherein Hedger 505 finances, installs, and/or leases distributed energy resources at a cost in exchange for cash flows from the end-users. Distributed energy assets may be packaged or bundled with similar assets and matched with one or more suitable off-takers 506.

In an alternative embodiment, Hedger may purchase a bundle of distributed energy assets comprising agreements by end-users of distributed energy resources to purchase energy at fixed rates projected to be less than estimated future utility rates for the end-users; wherein Hedger swaps with one or more off-takers a first variable stream of cash flows based on a variable future utility rate and energy quantity for the off-taker for a second variable stream of cash flows based on a variable rate and the energy quantity for the off-taker.

While embodiments have been described using fixed-for-variable swaps, other embodiments may include index-linked bonds or other investment vehicles such as strips, derivatives, secondary offerings, tiering of cash flows, etc.

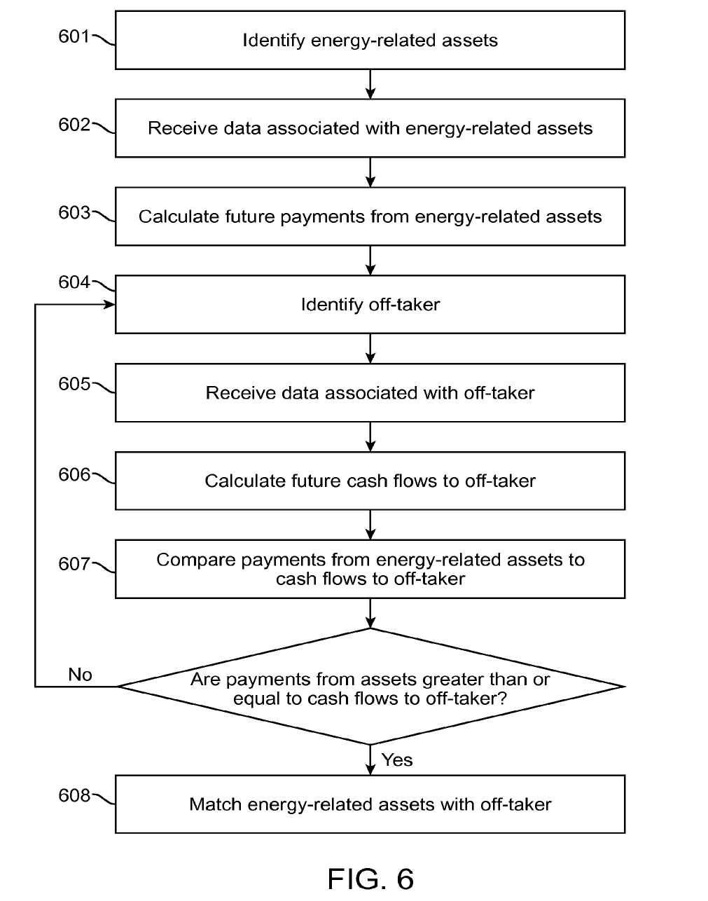

In any of the above systems it is desirable to match distributed energy assets with off-takers based on predicted cash flows in order to minimize basis risk. FIG. 6 shows a method of matching distributed energy assets with an off-taker. At step 601, energy related assets are identified. In one embodiment a bundle of energy related assets are identified. Alternatively a single energy-related asset may be identified.

At step 602, energy-related data associated with the asset is received. Received data may be any data relevant to the distributed energy assets such as data relating to laws, regulations, taxes, government incentives, utility incentives, usage data, equipment performance, utility pricing, weather, macroeconomic data, and/or technology data.

At step 603, estimated future payments from the distributed energy assets are calculated based on the received data. In an embodiment, calculating estimated future payments from the distributed energy assets comprises calculating estimated future utility rates for the distributed energy assets. Calculating future payments may also comprise calculating an estimated future energy quantity for the distributed energy assets such as energy consumption or energy production by the equipment.

At step 604, one or more off-takers are identified. At step 605, energy-related data associated with the off-taker is received. Received data may be any data relevant to the off-taker such as data relating to laws, regulations, taxes, government incentives, utility incentives, usage data, equipment performance, utility pricing, weather, macroeconomic data, and/or technology data.

At step 606, estimated future cash flows to the off-taker are calculated based on the received data. In an embodiment, calculating estimated future cash flows to the off-taker assets comprises calculating estimated future utility rates for the off-taker. Calculating future cash flows to the off-taker may also comprise calculating an estimated future energy quantity for the off-taker such as energy consumption.

At step 607, the estimated future payments from the distributed energy assets are compared to the estimated future cash flows to the off-taker. If the estimated future payments from the distributed energy assets are less than the estimated future cash flows to the off-taker then step 604 is repeated and another off-taker is identified. If the estimated future payments from the distributed energy assets are greater than or equal to the estimated future cash flows to the off-taker then the distributed energy assets and the off-taker are matched at step 608. The processes in FIG. 6 may be repeated multiple times until the distributed energy assets and an off-taker are matched.

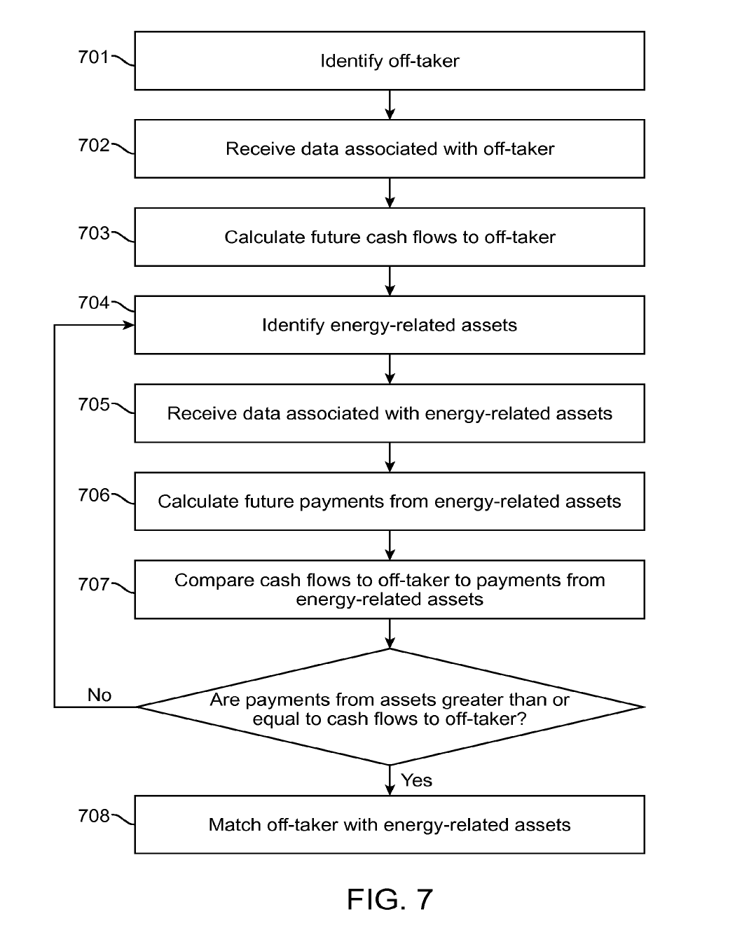

FIG. 7 shows an alternative method of matching distributed energy assets with an off-taker. At step 701, one or more off-takers are identified. At step 702, energy-related data associated with the off-taker is received. Received data may be any data relevant to the off-taker such as data relating to laws, regulations, taxes, government incentives, utility incentives, usage data, equipment performance, utility pricing, weather, macroeconomic data, and/or technology data.

At step 703, estimated future cash flows to the off-taker are calculated based on the received data. In an embodiment, calculating estimated future cash flows to the off-taker assets comprises calculating estimated future utility rates for the off-taker. Calculating future cash flows to the off-taker may also comprise calculating an estimated future energy quantity for the off-taker such as energy consumption.

At step 704, energy related assets are identified. In one embodiment a bundle of energy related assets are identified. Alternatively a single energy related asset may be identified.

At step 705, energy-related data associated with the asset is received. Received data may be any data relevant to the distributed energy assets such as data relating to laws, regulations, taxes, government incentives, utility incentives, usage data, equipment performance, utility pricing, weather, macroeconomic data, and/or technology data.

At step 706, estimated future payments from the distributed energy assets are calculated based on the received data. In an embodiment, calculating estimated future payments from the distributed energy assets comprises calculating estimated future utility rates for the distributed energy assets. Calculating future payments may also comprise calculating an estimated future energy quantity for the distributed energy assets such as energy consumption or energy production by the equipment.

At step 707, the estimated future payments from the distributed energy assets are compared to the estimated future cash flows to the off-taker. If the estimated future payments from the distributed energy assets are less than the estimated future cash flows to the off-taker then step 704 is repeated and another off-taker is identified. If the estimated future payments from the distributed energy assets are greater than or equal to the estimated future cash flows to the off-taker then the distributed energy assets and the off-taker are matched at step 708. The processes in FIG. 7 may be repeated multiple times until the off-taker and a bundle of distributed energy assets are matched.

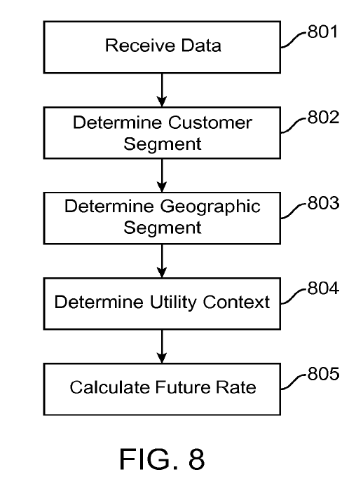

In any of the above systems or methods it may be desirable to calculate estimated future retail utility rates for a utility customer. FIG. 8 shows an exemplary method of calculating estimated future retail utility rates. At step 801, energy-related data comprising utility data, government data, weather data, economic data, usage data, event data, and/or technology data is received. At step 802, a relevant utility customer segment is determined for the utility customer. Utility customer segments may be based on utility customer sectors such as residential, commercial, industrial, agricultural, governmental, educational, or nonprofit. Utility customer segments may further be based on other factors such as income of the customer. At step 803, a geographic segment for the utility customer is determined. At step 804, the system then determines a utility effecting context to the utility data, government data, weather data, economic data, usage data, event data, and/or technology data. An estimated future retail utility rate is then calculated at step 805 based on the determined utility effecting context, utility customer segment, and geographic segment.

The system may repeat any of the above steps multiple times continuously or periodically in order to dynamically adjust the estimated future utility rate due to changes in relevant factors. In an embodiment, additional energy-related data representing additional factors not used in calculating the previously calculated estimated future utility rate or changes to factors used in calculating the previously calculated estimated future utility rate are received. The estimated future utility rate may then be recalculated based on the received additional energy-related data.

In one embodiment, calculating an estimated future retail utility rate comprises receiving energy-related data associated with a first geographic segment, and calculating an estimated future utility rate for a second geographic segment based on the received data associated with the first geographic region. In another embodiment, calculating an estimated future utility rate comprises predicting changes to taxes, statutes, or regulations.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in a computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

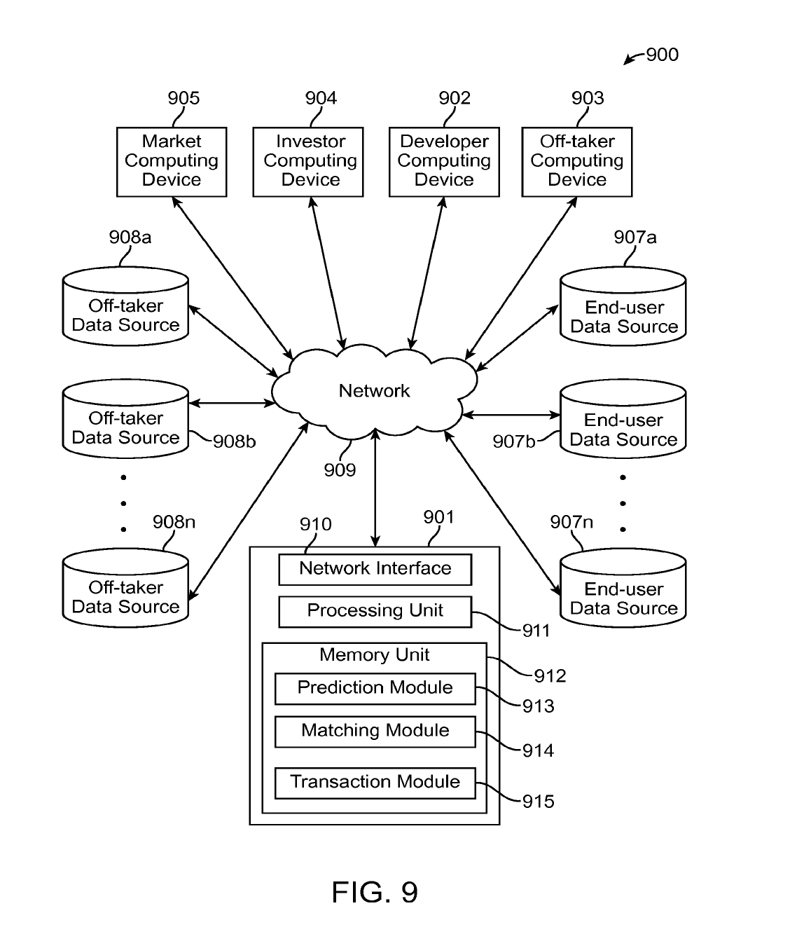

FIG. 9 illustrates an exemplary system architecture according to one embodiment. The system 900 may comprise one or more hedger computing devices 901, one or more developer computing devices 902, one or more off-taker computing devices 903 one or more investor computing devices 904, one or more market computing devices 905, one or more end-user data sources 907a-n, one or more off-taker data sources 908a-n, and one or more networks 909. The hedger computing device 901 is configured to communicate with developer computing device 902, off-taker computing device 903 investor computing device 904, market computing device 905, end-user data sources 907a-n, and/or off-taker data sources 908a-n over the network 909.

Computing devices 901, 902, 903, 904, 905 and data sources 907a-n, 908a-n may comprise various components including but not limited to one or more processing units, memory units, video or display interfaces, network interfaces, input/output interfaces and buses that connect the various units and interfaces. The network interfaces enable the computing devices 901, 902, 903, 904, 905 and data sources 907a-n, 908a-n to connect to the network 909. The memory units may comprise random access memory (RAM), read only memory (ROM), electronic erasable programmable read-only memory (EEPROM), and basic input/output system (BIOS). The memory unit may further comprise other storage units such as non-volatile storage including magnetic disk drives, optical drives, flash memory and the like.

In one embodiment the memory 912 may comprise a prediction module 913, a matching module 914, and a transaction module 915. Prediction module 913 may be configured to calculate estimated future utility rates for the off-taker/end-users, energy usage associated with the off-taker/end-users, energy production of equipment, payments, and cash flows. Matching module 914 is configured to match assets or bundles of assets with off-takers. Transaction module 915 is configured to sell or buy assets or bundles of assets and/or sell or buy cash flows. Transaction module 915 may be configured to communicate or initiate various transactions directly with investor computing device 904, developer computing device 902, and/or off-taker computing device 903. Transaction module 915 may also be configured to buy or sell assets or bundles of assets and/or buy or sell cash flows via transactions with a market computing device 905. The modules 913, 914, 915 may be implemented as software code to be executed by the processing unit 911 using any suitable computer language. The software code may be stored as a series of instructions or commands in the memory unit 912.

While FIG. 9 depicts one hedger computing device 901, one developer computing device 902, one off-taker computing device 903, one investor computing device 904, one market computing devices 905, and one network 909, this is meant as merely exemplary. Alternatively, any number of computing devices 901, 902, 903, 904, 905, data sources 907a-n, 908a-n, or networks 909 may be present. Some or all of the components of the computing devices 901, 902, 903, 904, 905 and/or the data sources 907a-n, 908a-n may be combined into a single component. Likewise, some or all of the components of the computing devices 901, 902, 903, 904, 905 and/or the data sources 907a-n, 908a-n may be separated into distinct components.

End-user data sources 907a-n provide data feeds that inform on events or factors related to the bundle of distributed energy assets. This data may then be used to calculate future payments from the bundle of distributed energy assets. Likewise, off-taker data sources 908a-n provide data feeds that inform on events or factors related to the off-taker. This data may then be used to calculate future cash flows to the off-taker. Data sources 907a-n, 908a-n may contain current data, historic data, and/or projected data.

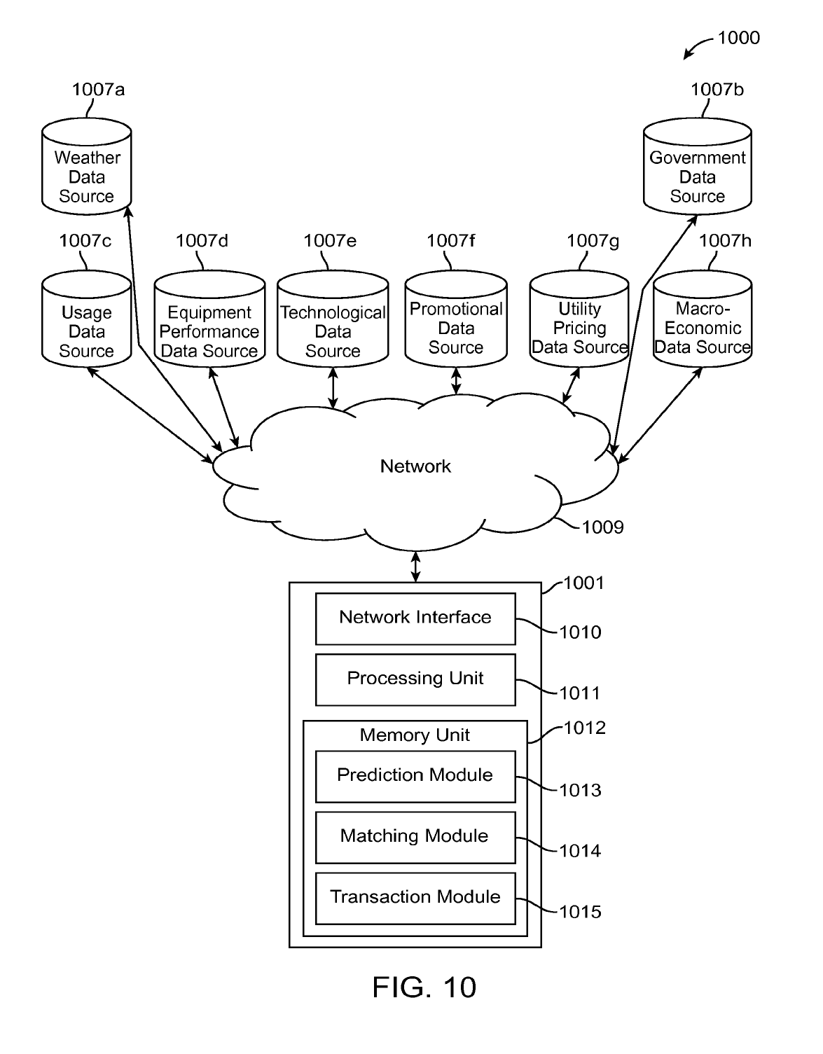

FIG. 10 illustrates an exemplary system architecture with various end-user and off-taker data sources. The system 1000 may comprise one or more hedger computing devices 1001, one or more data sources 1007a-h, and one or more networks 1009. The hedger computing device 1001 is configured to communicate with data sources 1007a-h over the network 1009. Hedger computing device 1001 may comprise various components including but not limited to one or more processing units 1011, memory units 1012, video or display interfaces, network interfaces 1010, input/output interfaces and buses that connect the various units and interfaces. Memory 1012 may comprise a prediction module 1013, a matching module 1014, and a transaction module 1015. Prediction module 1013 may be configured to calculate estimated future utility rates for the off-taker/end-users, energy usage associated with the off-taker/end-users, energy production of equipment, payments, and cash flows. Matching module 1014 is configured to match assets or bundles of assets with off-takers. Transaction module 1015 is configured to sell or buy assets or bundles of assets and/or sell or buy cash flows.

Data sources 1007a-h may be end-user data sources and/or off-taker data sources. Equipment performance data source 1007d may comprise equipment performance data relating to the performance of the end-user or off-taker equipment. Equipment performance may change over time due to many factors such as weather, quality, maintenance, or usage patterns. Adopted equipment may be monitored and performance can be rated based on actual performance. In one embodiment the equipment performance data source comprises sensors or other equipment adopted by the end-user.

Macroeconomic data source 1007h may comprise macroeconomic data at world, national, state, or local levels such as inflation/deflation data, CPI rates, employment data, commodity price data, home price data, recession/depression data, etc.

Weather data source 1007a may provide weather data relating to changes to average temperatures, precipitation, sunlight, wind, or other weather over time, hot or cold spikes in temperature, drought, flooding, earthquakes, natural disasters, or seasonal variation in weather.

Utility pricing data source 1007g comprises utility pricing data relating to the price of energy or water. Utility pricing data source 1007g may provide data relating to tariff structures (net metering, tiering of rates, demand changes, time-of-use pricing, fixed rates, variable rates, etc.), energy or water rationing, regulation or deregulation, carbon taxes or credits, changes in tax rates, changes to interpretation of tax or energy regulations, per unit rates, transmission fees, distribution policies, fuel mix, fuel prices, or events such as an oil embargo, refinery fires, closing or opening of utility plants.

Government data source 1007b may comprise government related data at the federal, state, or local level relevant to the asset or off-taker. Data may include information relating to tax rates, forms of taxes, tax treatment, statutes or regulations, government incentives, policies, legal or administrative rulings, elections, or political forces.

Usage data source 1007c may provide usage data relating to the distributed energy assets or the off-taker 1007c. In an embodiment, usage data may be provided by sensors, appliances, smart devices, meters, or other distributed energy resources associated with the end-user or off-taker. In another embodiment usage data is collected from a utility. Usage data may include data relating to past, current, or projected future usage. Usage data may also include energy consumption or production data, equipment use data, time of use data, duration of use data, or end-user behavioral data. Usage data may be based on various factors such as addition or subtraction of appliances or vehicles, addition or subtraction of energy generating equipment or distributed energy equipment, addition or subtraction of energy/water storage capabilities, changes to heating/cooling equipment, new or updated efficiency equipment or software, changes to equipment for cleaning, processing, storing, or purifying water, changes in time of use, changes in usage of the premises such as usage of the home as an office, etc., change in the number of occupants and intensity of usage, modifications to the property such as expansion or contraction, transfer of ownership, or change in occupants.

Energy-related technological data may also be provided by technological data source 1007e. Energy-related technological data may comprise data related to technological changes or predicted technological changes. For example, improved versions of end-user, off-taker, or utility equipment or new types of equipment that are more efficient or have additional features may emerge.

Promotional data source 1007f may comprise promotional data from public or private sources such as manufacturers, utilities, installers, sellers, or government. For example, a new rebate, credit, and/or incentive may exist to replace existing equipment with new equipment. Existing incentives may also be removed over time. There may also be negative promotions such as assessments, penalties, use fees, connection charges, new taxes, etc.

The various components depicted in FIGS. 9 and 10 may comprise computing devices or reside on computing devices such as servers, desktop computers, laptop computers, tablet computers, personal digital assistants (PDA), smartphones, mobile phones, smart devices, appliances, sensors, or the like. Computing devices may comprise processors, memories, network interfaces, peripheral interfaces, and the like. Some or all of the components may comprise or reside on separate computing devices. Some or all of the components depicted may comprise or reside on the same computing device.

The various components in FIGS. 9 and 10 may be configured to communicate directly or indirectly with a wireless network such as through a base station, a router, switch, or other computing devices. In an embodiment, the components may be configured to utilize various communication protocols such as Global System for Mobile Communications (GSM), General Packet Radio Services (GPRS), Enhanced Data GSM Environment (EDGE), Code Division Multiple Access (CDMA), Wideband Code Division Multiple Access (WCDMA), Bluetooth, High Speed Packet Access (HSPA), Long Term Evolution (LTE), and Worldwide Interoperability for Microwave Access (WiMAX).

The components may be further configured to utilize user datagram protocol (UDP), transport control protocol (TCP), Wi-Fi, satellite links and various other communication protocols, technologies, or methods. Additionally, the components may be configured to connect to an electronic network without communicating through a wireless network. The components may be configured to utilize analog telephone lines (dial-up connection), digital lines (T1, T2, T3, T4, or the like), Digital Subscriber lines (DSL), Ethernet, or the like. It is further contemplated that the components may be connected directly to a computing device through a USB port, Bluetooth, infrared (IR), Firewire port, thunderbolt port, ad-hoc wireless connection, or the like. Components may be configured to send, receive, and/or manage messages such as email, short message service (SMS), instant message (IM), multimedia message services (MMS), or the like.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A computerized method for mitigating risk in distributed energy assets comprising:
purchasing, using a processor, a bundle of distributed energy assets, wherein the distributed energy assets comprise agreements by end-users of distributed energy resources to purchase energy at variable rates which are tied to future utility rates or an index; and
swapping with one or more off-takers, using the processor, a variable stream of cash flows for a fixed stream of cash flows, wherein the variable stream of cash flows is based on a variable future utility rate and energy quantity for the off-taker, and wherein the fixed stream of cash flows is based on a fixed rate and the energy quantity for the off-taker.

2. The method of claim 1, wherein the variable rates of the distributed energy assets are discounted by a percentage from the future utility rates for the end-users.

3. The method of claim 1, wherein the variable rates of the distributed energy assets are discounted by a fixed value from the future utility rates for the end-users.

4. The method of claim 1, wherein the variable rates of the distributed energy assets are discounted from the future utility rates for the off-taker.

5. The method of claim 1, wherein the variable rates of the distributed energy assets are tied to average national utility rates, average regional utility rates, commodity prices, home prices, or inflation.

6. The method of claim 1, further comprising:
identifying the bundle of distributed energy assets;
receiving energy-related data associated with the bundle of distributed energy assets;
calculating future payments from the bundle of distributed energy assets based on the energy-related data associated with the bundle of distributed energy assets;
identifying the off-taker;
receiving energy-related data associated with the off-taker;
calculating future cash flows to the off-taker based on the energy-related data associated with the bundle of distributed energy assets; and
matching the bundle of distributed energy assets with the off-taker based on the calculated future payments from the bundle of distributed energy assets and the calculated future cash flows to the off-taker.

7. The method of claim 6, wherein the received energy-related data associated with the bundle of distributed energy assets or the received energy-related data associated with the off-taker comprise data relating to changes to regulations, taxes, government incentives, utility incentives, usage data, equipment performance data, utility pricing, macroeconomic data, weather, or technology data.

8. The method of claim 6, wherein calculating future payments from the bundle of distributed energy assets comprises calculating estimated future utility rates for the bundle of distributed energy assets; and calculating future cash flows to the off-taker comprises calculating estimated future utility rates for the off-taker.

9. The method of claim 6, wherein calculating future payments from the bundle of distributed energy assets comprises calculating an estimated future energy quantity for the bundle of distributed energy assets; and calculating future cash flows to the off-taker comprises calculating an estimated future energy quantity for the off-taker. 10, The method of claim 6, wherein the calculated future payments from the bundle of distributed energy assets is greater than or equal to the calculated future cash flows to the off-taker.

11. The method of claim 1, wherein the end-user utility rates are residential utility rates and the off-taker utility rates are commercial, industrial, or agricultural utility rates.

12. The method of claim 1, wherein the end-users and the off-taker are in different geographic regions.

13. The method of claim 1, further comprising selling to an investor the fixed stream of cash flows from the off-taker.

14. The method of claim 13, wherein the fixed stream of cash flows are sold to the investor at a price greater than or equal to the purchase price of the bundle of distributed energy assets.

15. The method of claim 1, wherein the distributed energy resources comprise photovoltaic, solar thermal, wind energy, heating, cooling, HVAC, insulation, energy storage, energy software, water processing, or water purifying equipment.

16. A computerized method for mitigating risk in distributed energy assets comprising:
purchasing, using a processor, a bundle of distributed energy assets, wherein the distributed energy assets comprise agreements by end-users of distributed energy resources to purchase energy at fixed rates; and
swapping with one or more off-takers, using the processor, a variable stream of cash flows for a fixed stream of cash flows, wherein the variable stream of cash flows is based on a variable future utility rate and energy quantity for the off-taker, and wherein the fixed stream of cash flows is based on a fixed rate and the energy quantity for the off-taker.

17. The method of claim 16, further comprising:
identifying the bundle of distributed energy assets;
receiving energy-related data associated with the bundle of distributed energy assets;
calculating future payments from the bundle of distributed energy assets based on the energy-related data associated with the bundle of distributed energy assets;
identifying the off-taker;
receiving energy-related data associated with the off-taker;
calculating future cash flows to the off-taker based on the energy-related data associated with the bundle of distributed energy assets; and
matching the bundle of distributed energy assets with the off-taker based on the calculated future payments from the bundle of distributed energy assets and the calculated future cash flows to the off-taker.

18. The method of claim 17, wherein the received energy-related data associated with the bundle of distributed energy assets or the received energy-related data associated with the off-taker comprise data relating to changes to regulations, taxes, government incentives, utility incentives, usage data, equipment performance data, utility pricing, macroeconomic data, weather, or technology data.

19. The method of claim 17, wherein calculating future cash flows to the off-taker comprises calculating estimated future utility rates for the off-taker.

20. The method of claim 17, wherein calculating future payments from the bundle of distributed energy assets comprises calculating an estimated future energy quantity for the bundle of distributed energy assets; and calculating future cash flows to the off-taker comprises calculating an estimated future energy quantity for the off-taker.

21. The method of claim 17, wherein the calculated future payments from the bundle of distributed energy assets is greater than or equal to the calculated future cash flows to the off-taker.

22. The method of claim 16, wherein the end-users and the off-taker are in different geographic regions.

23. The method of claim 16, further comprising selling to an investor the fixed stream of cash flows from the off-taker.

24. The method of claim 23, wherein the fixed stream of cash flows are sold to the investor at a price greater than or equal to the purchase price of the bundle of distributed energy assets.

25. The method of claim 16, wherein the distributed energy resources comprise photovoltaic, solar thermal, wind energy, heating, cooling, HVAC, insulation, energy storage, energy software, water processing, or water purifying equipment.

26. A computerized method for mitigating risk in distributed energy assets comprising:
purchasing, using a processor, a bundle of distributed energy assets, wherein the distributed energy assets comprise agreements by end-users of distributed energy resources to purchase energy at fixed rates; and
swapping with one or more off-takers, using the processor, a first variable stream of cash flows for a second variable stream of cash flows, wherein the first variable stream of cash flows is based on a variable future utility rate and energy quantity for the off-taker, and wherein the second variable stream of cash flows is based on a variable rate and the energy quantity for the off-taker.

27. The method of claim 26, further comprising:
identifying the bundle of distributed energy assets;
receiving energy-related data associated with the bundle of distributed energy assets;
calculating future payments from the bundle of distributed energy assets based on the energy-related data associated with the bundle of distributed energy assets;
identifying the off-taker;
receiving energy-related data associated with the off-taker;
calculating future cash flows to the off-taker based on the energy-related data associated with the bundle of distributed energy assets; and
matching the bundle of distributed energy assets with the off-taker based on the calculated future payments from the bundle of distributed energy assets and the calculated future cash flows to the off-taker.

28. The method of claim 27, wherein the received energy-related data associated with the bundle of distributed energy assets or the received energy-related data associated with the off-taker comprise data relating to changes to regulations, taxes, government incentives, utility incentives, usage data, equipment performance data, utility pricing, macroeconomic data, weather, or technology data.

29. The method of claim 27, wherein calculating future cash flows to the off-taker comprises calculating estimated future utility rates for the off-taker.

30. The method of claim 27, wherein calculating future payments from the bundle of distributed energy assets comprises calculating an estimated future energy quantity for the bundle of distributed energy assets; and calculating future cash flows to the off-taker comprises calculating an estimated future energy quantity for the off-taker.

31. The method of claim 27, wherein the calculated future payments from the bundle of distributed energy assets is greater than or equal to the calculated future cash flows to the off-taker.

32. The method of claim 26, wherein the end-users and the off-taker are in different geographic regions.

33. The method of claim 26, further comprising selling to an investor the fixed stream of cash flows from the off-taker.

34. The method of claim 33, wherein the second variable stream of cash flows are sold to the investor at a price greater than or equal to the purchase price of the bundle of distributed energy assets.

35. The method of claim 26, wherein the distributed energy resources comprise photovoltaic, solar thermal, wind energy, heating, cooling, HVAC, insulation, water processing, or water purifying equipment.

36. A dynamic computerized method for calculating estimated future retail utility rates comprising:
receiving by a processor, energy-related data, wherein the received data comprises utility data, government data, weather data, economic data, usage data, event data, and technology data;
determining by the processor a utility customer segment;
determining by the processor a geographic segment;
determining by the processor a utility effecting context to the utility data, government data, weather data, economic data, usage data, event data, and technology data; and
calculating by the processor an estimated future retail utility rate based on the determined utility effecting context, utility customer segment, and geographic segment.

37. The method of claim 36 comprising:
receiving energy-related data associated with a first geographic segment; and
calculating an estimated future utility rate for a second geographic segment based on the received data associated with the first geographic region.

38. The method of claim 36 further comprising:
receiving additional energy-related data representing additional factors not used in calculating the previously calculated estimated future utility rate or changes to factors used in calculating the previously calculated estimated future utility rate; and
recalculating the estimated future utility rate based on the received additional energy-related data.

39. The method of claim 36 wherein calculating an estimated future utility rate comprises predicting changes to taxes, statutes, or regulations.

40. The method of claim 36 wherein the received data comprises election, public opinion, or political data.

41. The method of claim 36 wherein the received data comprises data relating to opening or closing of a utility.

42. The method of claim 36 wherein the received data comprises data relating to changes to taxes, statutes, regulations, government incentives, legal rulings, administrative rulings, government policies, or political forces.

43. The method of claim 36, wherein the received data comprises data relating to utility pricing changes.

44. The method of claim 36, wherein the received data comprises data relating to fuel sources of a utility.

45. The method of claim 36, wherein the received data comprises data relating to transmission or distribution of electricity.
